(19) United States
(12) Patent Application Publication
(10) Pub. No.: US 2006/0271304 A1
(43) Pub. Date: Nov. 30, 2006

(54) Systems and methods for fast reachability queries in large graphs

(75) Inventors: Hao He, Durham, NC (US); Haixun Wang, Tarrytown, NY (US); Philip S. Yu, Chappaqua, NY (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 11/141,548

(22) Filed: May 31, 2005

(51) Int. Cl. G06F 19/00; G06F 7/00

(52) U.S. Cl. 702/19; 707/102

(57) ABSTRACT

A method which identifies different types of substructures within a graph and encodes them using techniques suitable to the characteristics of each of them. The method is embodied by an efficient two-phase algorithm, where the first phase identifies and encodes strongly connected components as well as tree substructures, and the second phase encodes the remaining reachability relationships by compressing dense rectangular submatrices in the transitive closure matrix.

### FIELD OF THE INVENTION

The present invention generally relates to the testing of reachability between nodes in a graph and related problems.

### BACKGROUND OF THE INVENTION

Numerals presented herebelow in brackets—[ ]—are keyed to the list of references found towards the close of the present disclosure.

Testing the reachability between nodes in a graph is a well-known problem with many important applications, including knowledge representation, program analysis, and more recently, biological and ontology databases inferencing as well as XML query processing. Generally, as discussed below, various approaches have been proposed to encode graph reachability information using node labeling schemes, but most existing schemes only work well for specific types of graphs.

One may consider a directed graph G=(V,E). Graph reachability is the following decision problem: Given two nodes u and v in G, is there a path from u to v? If the answer is yes, one can say that u can reach v, or

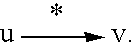

Graph reachability has been a well-known problem with many traditional applications, e.g., testing concept subsumption in knowledge representation systems; and reasoning about inheritance in compiler design for object-oriented programming languages. Recently, the interest in graph reachability work has been rekindled by new applications of graph-structured databases. For example, several well-known projects in bioinformatics model data such as protein interactions, metabolic pathways and gene regulatory networks as directed graphs. A general example of such a representation is shown in FIG. 1. Nodes in such graphs represent entities such as compounds, promoters and proteins whereas edges specify how the entities are related. In these projects, researchers are interested in reachability questions such as whether a reactant u might indirectly activate or inhibit protein v through some chain of reactions. In Semantic Web, two key technologies, the Resource Description Framework (RDF) and the Web Ontology Language (OWL), are designed to capture graph data. Reasoning and subsumption query on them are both reachability queries. In addition, although XML is generally modeled as a tree, there exist many XML applications where cross-reference edges (through IDREF/ID) are treated as first-class citizens, making the data graph-structured. In this case, the ancestor/descendant axis “u//v” of XML query is an instance of graph reachability query. Finally, the reachability query is also a basic building block of other types of graph queries such as subgraph isomorphism. Efficient support for reachability testing is crucial because this building block might be invoked heavily for large data and complex queries.

The well-known single-source shortest path algorithm can be used to answer reachability queries. However, the algorithm has a high complexity of O(|E|), making it infeasible for efficient query processing. At the other extreme, one can precompute and store the transitive closure of the graph. Reachability queries can then be answered with constant-time matrix lookups. However, the space requirement is O(|V|²), making this approach infeasible for large graphs.

If one only considers reachability in trees (or forests), interval labeling is a desirable solution that takes linear space and supports reachability queries in constant time. It labels each node u in the tree by an interval [start(u)end(u)]. The labels can be assigned with a depth-first traversal of the tree, using a counter that is incremented whenever the traversal enters or leaves a node; start(u) and end(u) are assigned the value of the counter when the traversal enters and leaves u, respectively. It is not difficult to see that interval labeling has the following property: Given two tree nodes u and v, 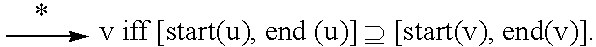
Thus, reachability can be verified in constant time. Unfortunately, this approach is not directly applicable to graphs.

Labeling a general graph to support efficient reachability queries is a difficult problem. It has been shown that there exist graphs for which any reachability labeling scheme would require O(|V|×|E|_{1/2}). Still, a variety of labeling schemes have been proposed, and they are surveyed herebelow. Briefly, the two most relevant and popular schemes are the interval-based approach by Agrawal et al. [1] and the 2-hop approach by Cohen et al. [2]. The interval-based approach extends the basic interval labeling to work on DAGs, and is effective on graphs that mostly resemble trees or forests. However, the performance degrades when the graph contains many non-tree edges. The 2-hop approach identifies subgraphs where one set of nodes connect to another set of nodes via a “hop” node; between these two sets, reachability relationships can be encoded compactly. This approach is thus optimized for graphs that contain many good “hop” nodes, i.e., nodes that connect two large sets of other nodes. However, the approach is less efficient for graphs with other types of substructures, e.g., long, branchless paths or one-way bipartite graphs.

Overall, there is currently no single approach that works well for all types of graphs. A need has thus been recognized in connection with providing a labeling scheme that is robust for a larger variety of graphs. It is noted that each existing approach to reachability labeling exploits certain substructural features in graphs; a need has thus also been recognized in connection with combining the strengths of different approaches to achieve generality in a labeling scheme.

### SUMMARY OF THE INVENTION

There is broadly contemplated herein, in accordance with at least one presently preferred embodiment of the present invention, a hierarchical approach to reachability labeling that may be referred to as HLSS (Hierarchical Labeling of Sub-Structures). A graph often contains different types of substructures whose reachability information is easier to encode with different labeling techniques. HLSS extracts such substructures and apply efficient labeling techniques suitable to each of them.

At least one embodiment of the present invention preferably involves a two-phase labeling algorithm, which implements HLSS. The first phase identifies and encodes strongly connected components as well as tree substructures. The second phase encodes the remaining reachability relationships by compressing dense rectangular submatrices in the transitive closure matrix. This hierarchical approach handles different types of graphs well, while existing approaches fall prey to graphs with substructures they are not designed to handle.

Preferably employed in accordance with at least one embodiment of the present invention is a 2-approximation algorithm to find dense submatrices. The method is ambiguity tolerant, that is, it allows false positives to encourage larger submatrices, which can be encoded more efficiently; meanwhile, it considers the cost of filtering out false positives to balance this benefit.

In summary, one aspect of the invention provides a method of providing reachability labeling for graphs, the method comprising the steps of: providing an input graph having at least one substructure associated therewith; and labeling the at least one substructure with reachability information in a manner optimally configured for the at least one substructure.

Another aspect of the invention provides an apparatus for providing reachability labeling for graphs, the apparatus comprising: an arrangement for providing an input graph having at least one substructure associated therewith; and an arrangement for labeling the at least one substructure with reachability information in a manner optimally configured for the at least one substructure.

Furthermore, an additional aspect of the invention provides a program storage device readable by machine, tangibly embodying a program of instructions executable by the machine to perform method steps for providing reachability labeling for graphs, the method comprising the steps of: providing an input graph having at least one substructure associated therewith; and labeling the at least one substructure with reachability information in a manner optimally configured for the at least one substructure.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 schematically illustrates an example of a pathway in a biological application.

FIG. 2 illustrates a path and corresponding submatrix.

FIG. 3 illustrates a one-way bipartite graph and transitive closure matrix.

FIG. 4 illustrates two sets of nodes and a corresponding submatrix.

FIG. 5 illustrates manipulation of a sample graph.

FIG. 6 provides an algorithm, “REDUCE”.

FIG. 7 provides an algorithm, “FINDDSM_{—}2APPROX(A)”.

FIG. 8 provides an algorithm, “FINDDSMEXT2HOP(A)”.

FIG. 9 provides an algorithm, “ENCODE(Gᵣ)”.

FIG. 10 provides an algorithm, “ISREACHABLE(u,v)”.

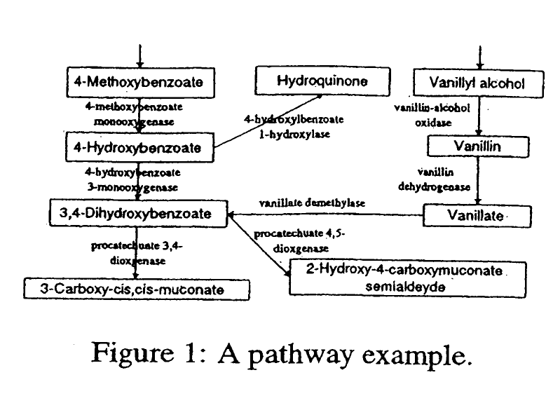

### DESCRIPTION OF THE PREFERRED EMBODIMENTS

To further the present discussion, one may recast the problem of graph reachability labeling as a problem of finding a compact representation for a transitive closure matrix. From this viewpoint, and for the purposes of providing a basis of comparison, two highly popular conventional approaches are discussed herebelow—namely, interval-based and 2-hop—followed by a brief discussion of other related work.

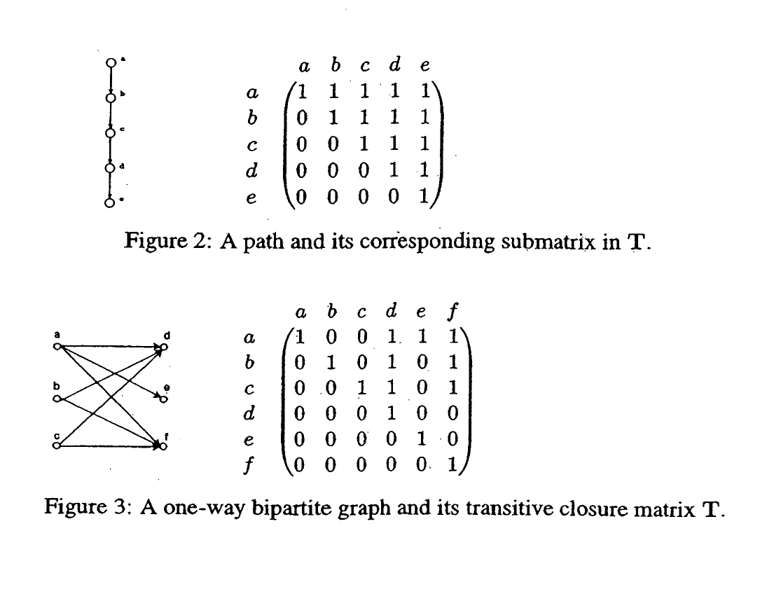

In an interval-based approach, nodes are labeled by intervals, whose containment relationships encode ancestor-descendant relationships among nodes in a tree. In the transitive closure matrix, each directed path in the graph corresponds to a reordered submatrix with ones in the upper triangle and zeros in the lower triangle (see FIG. 2). This submatrix can be encoded succinctly by labeling the nodes involved with nested intervals. Thus, the interval-based approach is effective in compressing those transitive closure matrices that contain many such upper triangular submatrices. This approach works especially well for graphs with long paths: The longer the path, the better the compression ratio.

Although originally proposed for trees, the interval-based approach was extended by Agrawal et al. [1] to DAGs. Each node u is assigned a set of non-overlapping intervals L(u); 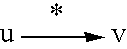
if every interval in L(v) is contained in some interval in L(u). Labeling is done by first finding a spanning forest and assigning interval labels for nodes in the forest. Next, to capture reachability relationships through non-spanning-forest edges, one adds additional intervals to labels in reverse topological order of the DAG; specifically, if (u,v) is an edge not in the spanning forest, then all intervals in L(v) are added to L(u) (as well as labels of all nodes that can reach u).

Consider the graph in FIG. 3. Using the spanning tree rooted at a, one labels a, d, e, and f with [1 8], [2,3], [4,5], and [6,7], respectively; one labels b and c with [9,10] and [11,12] as they belong to separate trees in the spanning forest. In addition, both b and c receive intervals from d and f resulting in L(b)={[9,10], [2,3], [6,7]} and L(c)={[11,12], [2,3], [6,7]}.

With more complicated graphs, the size of a label can become linear in the graph size. For example, if d and f have many non-spanning-forest descendants, their labels will become larger, which will in turn cause ancestors of b and c to have larger labels. Since reachability queries involves checking containment for all intervals in a label, large labels can seriously impact query performance.

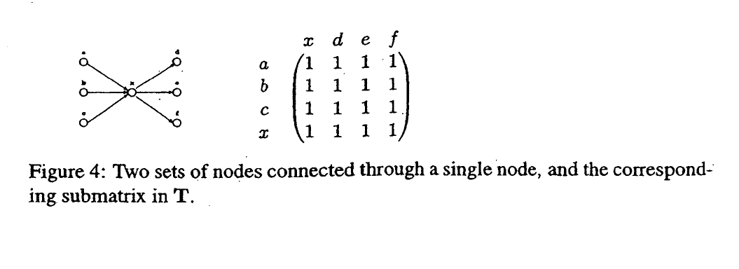

The 2-hop approach, on the other hand, was proposed as an alternative to the interval-based approach by Cohen et al. [2]. For each node u, let Cᵢₙ(u) denote the set of nodes that can reach u, let Cₒᵤₜ(u) the set of nodes that can be reached by u. The key observation of this approach is that every node in Cᵢₙ(u) and can reach every node in Cₒᵤₜ(u). For example, in FIG. 4, Cᵢₙ(x)={a, b, c, x} and Cₒᵤₜ(x)={x, d, e, f}. The 2-hop approach assigns each node two sets of nodes as its in-label and out-label, such that 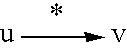
iff the out-label of u intersects with the in-label of v. Thus, reachability relationships from nodes in Cᵢₙ(x) to nodes in Cₒᵤₜ(x) can be encoded succinctly by adding x to the out-label of every node in Cᵢₙ(x), and the in-label of every node in Cₒᵤₜ(x).

From the viewpoint of compressing the transitive closure matrix, the 2-hop approach seeks to compress the submatrix induced by x consisting of all ones; its columns correspond to the nodes in Cᵢₙ(x) and its rows correspond to the nodes in Cₒᵤₜ(x), as illustrated in FIG. 4. Thus, the 2-hop approach works especially well on graphs with many well-connected hop nodes. The effectiveness of this approach depends on the area-to-circumference ratio of submatrices identified for compression: The larger the area compared with circumference, the better the compression ratio. Thus, the 2-hop algorithm repeatedly and greedily encodes the submatrix induced by the node x that maximizes

$$\frac{\vert {C}_{in} ( x ) \vert \times \vert {C}_{out} ( x ) \vert - k}{\vert {C}_{in} ( x ) \vert + \vert {C}_{out} ( x ) \vert} ,$$

where k is the number of ones in the submatrix that have been previously encoded.

On the other hand, it is clear from the matrix compression viewpoint that the 2-hop approach may miss many submatrices that are high-quality candidates for compression, because the approach only considers submatrices induced by hop nodes. For example, in FIG. 3, the submatrix spanned by columns {a, b, c} and rows {d,f} includes all ones and would be a good choice to compress, but it is not induced by a hop node.

As shown hereabove, existing approaches to labeling graph reachability each have their respective strengths and weaknesses, and are each most effective on specific types of graphs. For example, the interval-based approach works best on tree-like graphs, while the 2-hop approach works best on graphs with many well-connected hop nodes. By combining the power of these approaches and other optimizations, there is proposed herein HLSS, a hierarchical labeling scheme that can work well for graphs with different characteristics.

HLSS preferably assigns labels in two phases, each focusing on exploiting different characteristics of the input graph G. The first phase, tree-reachability reduction, begins with a preprocessing step that identifies each strongly connected component of the graph, collapses the component into one representative node, and uses this node to label others in the component. Then, one preferably identifies tree structures within G and assigns interval labels to nodes based on these tree structures. Containment of interval labels implies reachability through tree paths. This phase also computes a remainder graph Gᵣ that captures any remaining reachability information not encoded by interval labels. Specifically, a node can also reach another node through portals in Gᵣ. Each node is preferably labeled by their portals to facilitate reachability checking.

The second phase, remainder graph-reachability encoding, aims at compressing the reachability information in the remainder graph Gᵣ produced by the first phase. One may preferably do so by assigning additional labels to portals so that reachability among them can be checked efficiently by comparing their labels. Presented herein are several techniques for assigning such labels, including an enhanced version of the 2-hop approach as well as techniques inspired by data mining, linear algebra, and graph algorithms.

To summarize, these two phases will create a label of a 4-level hierarchy for each node u:
1. A strongly connected component label, lₛ(u), which is a representative node in the strongly connected component containing u, if any. It is assigned by the tree-reachability reduction phase.
2. A pair of numeric interval labels, lᵢ(u) and lᵢ(u), which form the interval [lᵢ(u),lᵢ(u)]. They are assigned by the tree-reachability reduction phase.
3. A pair of portal labels, lₚⁱⁿ(u) and lₚ^{out}(u), which are two portals of u in Gᵣ if they exist. They are also assigned by the tree-reachability reduction phase.
4. A pair of remainder labels, lᵣⁱⁿ(u) and lᵣ^{out}(u), each of which consists of a set of symbols in general. They are assigned by the remainder graph-reachability encoding phase.

The disclosure now turns to a description of how the two phases assign these labels. Further below is a discussion on how to answer reachability queries using these labels.

Preferably, there are identified strongly connected components in G that contain more than one node. If two nodes u and v belong to the same strongly connected component, they are indistinguishable from each other as far as reachability is concerned. For any node w, if 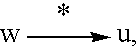
then 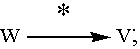
similarly, if 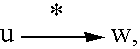
then 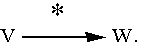
Hence, for the purpose of computing reachability, one can collapse each strongly connected component of G into one single representative node that retains all edges coming in and out of the strongly connected component. Subsequently, there will be dealt with only this representative node; nodes strongly connected to it receive it as their strongly connected component label (lₛ). One can find all strongly connected components of G in O(|V|+|E|) time, using Tarjan's algorithm. By replacing all strongly connected components with their representative nodes, there is obtained a result graph G′ with no cycles.

Next, there is preferably identified a spanning forest T of G′ and assign interval labels lᵢ(u) and lᵢ(u) to each node u to capture all reachability relationships in T. The identification of T and assignment of interval labels both can be done easily in time linear in the size of G′.

From G′, there is preferably found a remainder graph Gᵣ, which embodis reachability not covered by the spanning forest in G′. The remainder graph Gᵣ is usually much smaller than G′. Nodes of Gᵣ are a subset of nodes in G′, which one may call portals. One may preferably label each node u of G′ with two portals: an in-portal lₚⁱⁿ(u) and an out-portal lₚ^{out}(v). To support efficient reachability checking, portal labels and Gᵣ must have the following property:

(P1) For any two nodes u, vεG′,

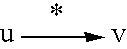

$$[ {l}_{i}^{} ( u ) , {l}_{i}^{} ( u ) ] ⊇ [ {l}_{i}^{} ( v ) , {l}_{i}^{} ( v ) ] , \\ or$$

$${l}_{p}^{out} ( u ) {⟶}^{*} {l}_{p}^{in} ( v ) in {G}_{r} .$$

In other words, unless u can reach v via tree edges in the spanning forest, the only way for u to reach v is by going through the out-portal of u and the in-portal of v.

To this end, one may preferably define lₚ^{out}(u), lₚⁱⁿ(u), and Gᵣ as follows:

Definition 1 (Portals and Remainder Graph) Given a spanning forest T of G′, a node uεG′ is exposed if there exists an edge (u,v)) (or (v, u)) in G′ such that u is not v's ancestor (or descendant, respectively) in T
The in-portal of u, lₚⁱⁿ(u) is u's lowest exposed ancestor in T, if any.
The out-portal of u, lₚ^{out}(u), is the lowest common ancestor of all u's exposed descendants in T, if any.
The remainder graph Gᵣ of G′ consists of nodes that are in-portals or out-portals of some nodes in G′. There is an edge between two nodes u and v in Gᵣ iff 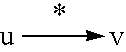
   in G′.

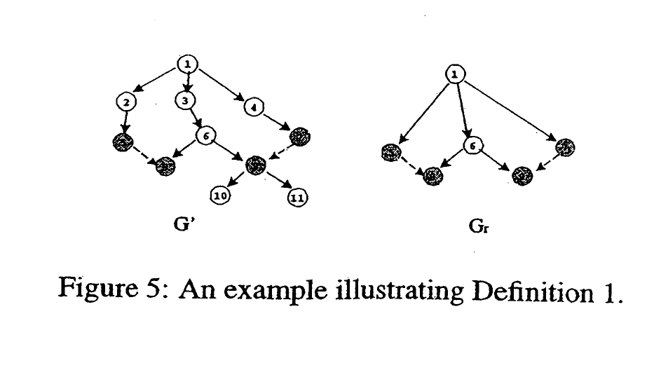

The definition of portals assumes that ancestor and descendant relationships are reflexive, i.e., a node is an ancestor and descendant of itself. Note that an outportal is not necessarily exposed; a non-exposed node can be an out-portal if it is the lowest common ancestor of some exposed nodes. FIG. 5 shows a sample graph G′, where solid edges belong to the spanning forest T. Based on the definition, gray nodes are exposed nodes. Node 6 is not exposed, but it is the out-portal of node 3 since it is the least common ancestor of all node 3's exposed descendants (nodes 8 and 9).

The following theorem ensures that the reduction of G′ into Gᵣ given by Definition 1 preserves all remaining reachability information.

Theorem 1 The portal labels and remainder graph defined by Definition 1 have property (P1).

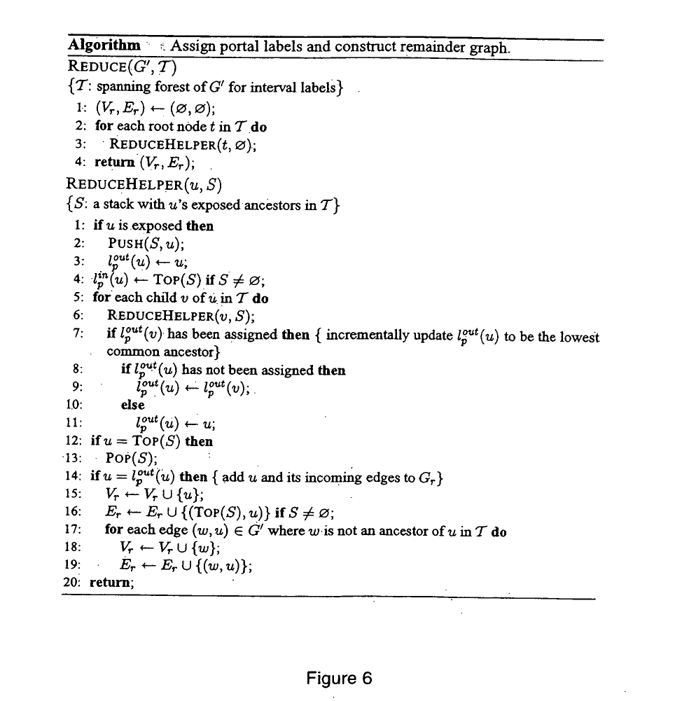

In FIG. 6, the algorithm “REDUCE” assigns portal labels and constructs the remainder graph in linear time. Basically, REDUCE performs a depth-first traversal on each tree in the spanning forest T. During the traversal, REDUCE maintains a stack of all exposed ancestors to make in-portal label assigmments. Out-portal labels are computed bottom-up. Portals and their incoming edges are added to the remainder graph as they are identified. In fact, one can augment REDUCE so that it can also find the spanning forest T and assign all interval labels in the same pass over G′. For clarity, however, there is only presented here how to assign portal labels and construct the remainder graph given T

Finally, it is noted in the following theorem that the size of the remainder graph is linear in the number of “non-tree” edges, i.e., those that are not in T or implied by T. Therefore, in practice, the remainder graph can be much smaller than the original graph. In particular, if the input graph is a tree or forest, the remainder graph would be empty and all portal labels would be unassigned, and the scheme basically degenerates into the interval-based approach.

Theorem 2 Let Eₙₜ denote the set of edges in G′ that are not from a node to its descendant in T. The remainder graph Gᵣ has fewer than 4|Eₙₜ| nodes and 5|Eₙₜ| edges.

After extracting reachability relationships in the spanning forest, one can now turn to the problem of encoding remaining reachability relationships in the remainder graph Gᵣ. As outlined below, an important objective in this phase is to assign the remainder labels Lᵣⁱⁿ(u) and Lᵣ^{out}(u) for each node u in Gᵣ to help checking reachability among nodes in Gᵣ. Let Tᵣ denote the transitive closure matrix of Gᵣ. The general idea is to compress the content of Tᵣ into remainder labels, in a way that allows any Tᵣ entry to be recovered efficiently.

While many compression algorithms can be applied to Tᵣ (e.g., Blocked Huffman coding or LZW), most of them do not support efficient recovery of individual entries. A presently preferred approach is to identify a dense submatrix of Tᵣ with mostly ones, and encode it compactly in remainder labels of the nodes associated with rows and columns of the submatrix. This process is repeated until unencoded ones in Tᵣ are sparse enough to be stored efficiently in a sparse matrix.

By way of encoding a dense submatrix, suppose R and C are two non-empty sets of nodes in the remainder graph Gᵣ. Let Tᵣ(R,C) denote the submatrix of Tᵣ spanned by R and C, i.e., the submatrix whose rows and columns correspond to nodes in R and C, respectively. This submatrix captures reachability relationships from R nodes to C nodes. To encode these reachability relationships, one may pick a unique symbol s; one may preferably then add s to Lᵣ^{out}(u) for each node uεR, and also to Lᵣⁱⁿ(u) for each node vεC. In addition, for each entry (u, v) of Tᵣ with value zero, one adds the pair (u, v) to a zero-exception set ε₀. Clearly, 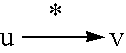
if

Lᵣ^{out}(u)∩Lᵣⁱⁿ(v)≠Ø and (u, v)∉ε_{0.}

Intuitively, adding a common symbol to |R|+|C| remainder labels has the effect of remembering Tᵣ(R, C) as a submatrix of all ones. Any zero in Tᵣ(R, C) needs to be remembered in ε₀ as an exception. Subsequently, one no longer needs to store entries of Tᵣ(R, C) in Tᵣ.

The amount of space used in remainder labels to encode Tᵣ(R, C) is (|R|+|C|)×size(s), where size(s) denotes the size of symbol s in bits; in addition, the amount of space used in the zero-exception set is n₀(Tᵣ(R, C))×size(e₀), where nₓ(•) counts the number of entries with value x in a matrix, and size(e₀) denotes the size of an entry in ε₀. One can quantify the quality of encoding by the encoding density of the submatrix Tᵣ(R, C), defined as the ratio between the number of ones in the submatrix and the amount of space used in encoding the submatrix:

$$density ( {T}_{r} ( R , C ) ) = \frac{{n}_{1} ( {T}_{r} ( R , C ) )}{( \vert R \vert + \vert C \vert \times size ( s ) + {n}_{0} ( {T}_{r} ( R , C ) ) \times size ( {e}_{0} )} . \qquad ( 1 )$$

The higher the encoding density of a submatrix—or in short, the denser the submatrix—the better it is to apply encoding. The overall remainder graph-reachability encoding algorithm, to be presented herebelow, greedily identifies a dense (if not the densest) submatrix of Tᵣ encodes it, marks its entries as encoded (using a value other than one or zero), and repeats the process. Thus, in the general case that parts of Tᵣ have already been encoded, Equation (1) defines the encoding density to be the ratio between the number of unencoded ones and the amount of additional space used in encoding (zeros covered by previously encoded parts are already remembered in ε₀ and thus do not require additional space).

The 2-hop approach also uses a notion of encoding density, which is essentially a restricted case of the definition above. As discussed hereabove, the main restriction is that the 2-hop approach only considers submatrices induced by single nodes. The submatrix of Tᵣ induced by node u is Tᵣ(Cᵢₙ(u),Cₒᵤₜ(u)), where, it is to be recalled, Cᵢₙ(u) is the set of nodes that can reach u and Cₒᵤₜ(u) is the set of nodes that can be reached by u Note that all entries in this submatrix are ones, so n₁(Tᵣ(Cᵢₙ(u), Cₒᵤₜ(u)))=|Cᵢₙ(u)|×|Cₒᵤₜ(u)| and n₀(Tᵣ(Cᵢₙ(u), Cₒᵤₜ(u)))=0. Hence, the definition of encoding density reduces (up to a constant factor) to the one used by the 2-hop approach:

$$\frac{\vert {C}_{in} ( u ) \vert \times \vert {C}_{out} ( u ) \vert - k}{\vert {C}_{in} ( u ) \vert + \vert {C}_{out} ( u ) \vert} ,$$

where k is the number of ones in the submatrix that have been previously encoded.

An important step of a remainder graph-reachability encoding algorithm involves identifying a submatrix of Tᵣ to encode, preferably the densest one. Before algorithms are presented for finding such submatrices, below is a formal definition of the general problem.

Definition 2(Densest submatrix problem) The densest submatrix problem (DSM) is defined as follows: Given a binary matrix A and non-negative parameters size(s) and size(e₀), find a subset R of rows and a subset C of columns from A that maximize density (A(R,C)), the encoding density of the submatrix spanned by R and C.

Theorem 3 Under the plausible assumption that 3-SAT does not have a subexponential time algorithm, DSM is hard to approximate within a factor of 2^{(log n) δ}−1 for some δ>0. Here, n denotes the total number of rows and columns in the input matrix to the DSM problem.

This result implies that, for the general DSM problem, it may be fruitless to go after the optimal solution. Thus, one turns to heuristics that consider a restricted solution space or special instances of the DSM problem for which efficient approximation is possible.

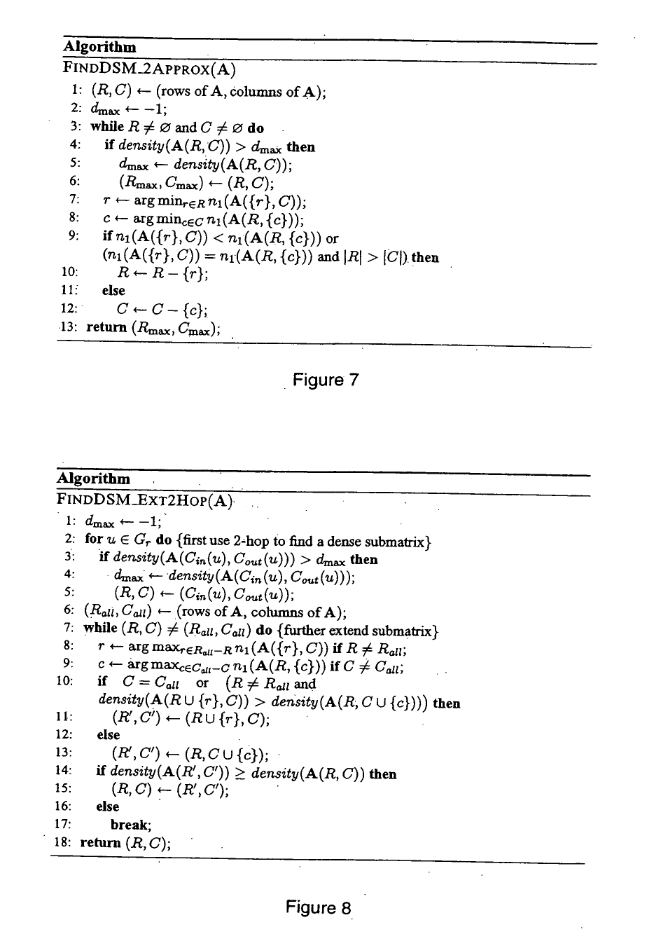

The first algorithm, FINDDSM_{—}2APPROX (FIG. 7), is greedy. To obtain a dense submatrix of A, the algorithm simply keeps removing the row or column with the least number of ones from A, one at a time. This process produces a sequence of submatrices as intermediate results. The densest submatrix among them is chosen.

FINDDSM_{—}2APPROX can be made an efficient O(n²) algorithm, where n denotes the total number of rows and columns in A. The main loop runs at most n times. Without any optimization, each iteration of the loop would take O(n²) time, most of which is spent on counting ones. However, for each row (or column) to be removed, one can remember the count of its ones, and update this count whenever a column (or row, respectively) is removed. This maintenance only takes O(n) time per iteration, and the cost of finding the row or column with the least number of ones is reduced to O(n) per iteration. Thus, one has reduced the overall complexity of FINDDSM_{—}2APPROX to O(n²). For simplicity of presentation, his optimization is not shown in the algorithm of FIG. 7.

Another bit of good news is that, for the instance of DSM with size(e₀)=0, FIND-DSM_{—}2APPROX turns out to be a 2-approximation algorithm, i.e., it returns a submatrix whose encoding density is in a factor of two of the densest one. Note that this instance of DSM is not at all unreasonable: Setting size(e₀)=0 in Equation (1) does not imply that the cost of zero-exception list is ignored, because the numerator, n1(A(R, C)), still favors submatrices with more ones.

Theorem 4 FINDDSM_{—}2APPROX is a 2-approximation algorithm for finding the densest submatrix A(R, C)) with encoding density defined as

$${density}_{2} ( A ( R , C ) ) = \frac{{n}_{1} ( A ( R , C ) )}{\vert R \vert + \vert C \vert} .$$

Recall that the 2-hop approach considers only submatrices induced by single nodes, and picks the densest submatrix among them. The approach does not consider any submatrix containing zeroes, or any submatrix corresponding to a bipartite subgraph such as the one illustrated in FIG. 3. A third algorithm, FINDDSM_EXT2HOP (FIG. 8), removes these limitations by further extending the densest submatrix found by the 2-hop approach with additional rows and columns as long as they increase density. The resulting submatrix may contain zeros, and its ones may correspond to paths that do not go through a common node. In sum, FINDDSM_EXT2HOP considers a larger solution space than the 2-hop approach, while using the solution found by the 2-hop approach to seed the search.

Like the other two algorithms presented just hereabove, FINDDSM_EXT2HOP takes O(n²) time. The 2-hop loop requires only O(n²) time, because density calculation is simplified by the fact that all submatrices considered by the 2-hop approach contain no zeros. The second loop for extending the result submatrix runs at most n times, and each iteration can be optimized to run in O(n) time using two optimizations that one has applied earlier to the other two algorithms in this section. First, for each remaining row (or column), one can record the count of ones that it can add to the current submatrix, and update this count whenever a column (or row, respectively) is added; this optimization brings down the cost of finding the row and column with the most ones to O(n). Second, one can record the numbers of ones and zeros in the submatrix and update the two counts in each iteration; this optimization brings down the cost of density calculation to O(n). Overall, the complexity of FINDDSM_EXT2HOP becomes O(n²).

Also proposed herein is an algorithm based on the singular value decomposition. A matrix A can be decomposed to A=UΣV^{T} where U and V are orthogonal matrixes, and Σ is a diagonal matrix. The singular value σᵢ is the ith diagonal entry of Σ while the columns uᵢ of U and vᵢ of V are the corresponding singular vectors. A well-known result is that the best rank-k approximation of A in the least square sense is given by

$${A}_{k} = {\sum }_{i = 1}^{k} {σ}_{t} {u}_{i} {v}_{i}^{T} .$$

Consider the rank-1 approximation A₁=σ₁u₁v₁^{T}. Intuitively, the components of u₁ and v₁ with the most significant values should span the submatrix of A₁ with the most significant values. For the present problem, this submatrix of A₁ should correspond to a dense submatrix of A, because A₁ approximates A, a matrix with ones and zeros.

Therefore, there is proposed here a greedy algorithm FINDDSM_SVD based on the above intuition. Unfortunately, computing u₁ and v₁ requires O(n³) time, which makes the approach less desirable computationally.

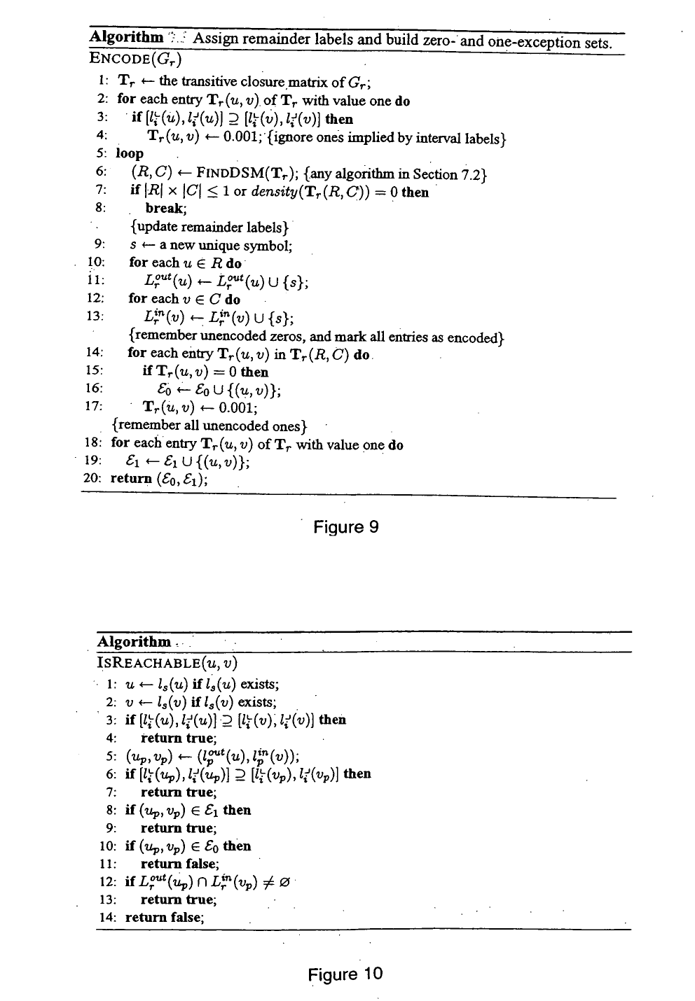

Next to be presented is ENCODE (FIG. 9), the overall algorithm for encoding remainder graph reachability. The input is the remainder graph Gᵣ. The algorithm first computes the transitive closure matrix Tᵣ for Gᵣ. In each iteration of its main loop, the algorithm greedily identifies a dense submatrix of Tᵣ using one of the three algorithms from FIGS. 6-8. The content of this submatrix is encoded in remainder labels and the zero-exception set ε₀, using the procedure described herein. Next, the algorithm marks the entries of the submatrix as already encoded, by setting their values to 0.001 (so chosen that the SVD used by FINDDSM_SVD can practically treat it as zero). As the loop continues, unencoded ones become fewer and sparser, submatrix densities become less, and dense submatrices become smaller. When eventually dimensions of candidate submatrices shrink to 1×1, one terminates the loop and remember all unencoded ones in a one-exception set ε₁. Both ε₀ and ε₁ can be implemented using hash tables.

Let m denote the number of nodes in Gᵣ (i.e., the portals). The running time of ENCODE is O(m³) (or O(m⁴) if one uses FINDDSM_SVD). Computation of the transitive closure matrix can be done easily in O(m³), using a simplified version of the Floyd-Warshall algorithm. One can control the main loop so that it executes at most O(m) times. First, note that FINDDSM_EXT2HOP can be run O(m) times before triggering the break condition of the main loop, because each run uses up one hop node. For FINDDSM_{—}2APPROX and FINDDSM_SVD, one can run them O(m) times and then simply switch to running FINDDSM_EXT2HOP subsequently, which results in at most O(m) iterations of the main loop overall. The cost of each iteration is dominated by the cost of finding a dense submatrix, which takes O(m²) time for FINDDSM_{—}2APPROX and FINDDSM_EXT2HOP (or O(m³) for FINDDSM_SVD), as discussed herein.

Given two nodes u and v, testing whether 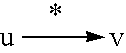
is straightforward. If either one has a strongly connected component label, the node in the label is checked instead. One may preferably first check their interval labels. If the answer is not affirmative, one may preferably look up their portal labels and check reachability between u's out-portal and v's in-portal, which involves testing whether their remainder labels intersect, and whether the pair belong to zero- and one-exception sets (implemented as hash tables). All steps take constant time except testing whether two remainder labels intersect, which can be done in time linear to the lengths of these labels.

FIG. 10 provides an algorithm, “ISREACHABLE(u, v)”, for deciding the reachability of two nodes with HLSS labels.

By way of brief recapitulation, many labeling schemes have been proposed in the past, but most of them are optimized to exploit particular types of substructures in graphs and do not work well on other substructures. Proposed herein is a hierarchical approach that combines the strengths of existing approaches by labeling different types of substructures differently.

It is to be understood that the present invention, in accordance with at least one presently preferred embodiment, includes an arrangement for providing an input graph having at least one substructure associated therewith, and an arrangement for labeling the at least one substructure with reachability information. Together, these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirely herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

### REFERENCES

[1] R. Agrawal, A. Borgida, and H. V. Jagadish. Efficient management of transitive relationships in large data and knowledge bases. In Proc. of the 1989 ACMSIGMOD Intl. Conf on Management of Data, 1989.
[2] Cohen, E. Halperin, H. Kaplan, and U. Zwick. Reachability and distance queries via 2-hop labels. In Proc. of the the 13th ACM-SIAM Symposium on Discrete algorithms, 2002.

What is claimed is:

1. A method of providing reachability labeling for graphs, said method comprising the steps of:
providing an input graph having at least one substructure associated therewith; and
labeling the at least one substructure with reachability information in a manner optimally configured for the at least one substructure.

2. The method according to claim 1, wherein:
the at least one substructure comprises a plurality of substructures;
said labeling step comprises separately labeling each substructure in a manner optimally configured for each substructure.

3. The method according to claim 1, wherein said labeling step is performed in two phases, wherein each of the two phases addresses different dedicated characteristics of the input graph.

4. The method according to claim 3, wherein said labeling step comprises, in a first of the two phases:
identifying strongly connected components in the input graph;
collapsing each strongly connected component into a representative node; and
employing the representative node to label other items associated with the strongly connected component.

5. The method according to claim 4, wherein said labeling step further comprises, in the first phase:
identifying at least one tree structure in the input graph; and
assigning interval labels to nodes in the input graph based on the at least one tree structure.

6. The method according to claim 5, wherein said labeling step further comprises, in the first phase, determining a remainder graph comprising reachability information not provided by the interval labels.

7. The method according to claim 6, wherein said assigning step comprises identifying at least one portal between nodes in the remainder graph.

8. The method according to claim 6, wherein said labeling step comprises, in a second of the two phases, compressing reachability information in the remainder graph.

9. The method according to claim 8, wherein:
said assigning step comprises identifying at least one portal between nodes in the remainder graph; and
said compressing step comprises assigning at least one additional label to at least one portal.

10. The method according to claim 1, further comprising the step of identifying at least one substructure which comprises a dense submatrix, via permitting false positives in identifying at least one dense submatrix while assessing a cost of filtering out false positives.

11. An apparatus for providing reachability labeling for graphs, said apparatus comprising:
an arrangement for providing an input graph having at least one substructure associated therewith; and
an arrangement for labeling the at least one substructure with reachability information in a manner optimally configured for the at least one substructure.

12. The apparatus according to claim 11, wherein:
the at least one substructure comprises a plurality of substructures;
said labeling arrangement is adapted to separately label each substructure in a manner optimally configured for each substructure.

13. The apparatus according to claim 11, wherein said labeling arrangement is adapted to peform labeling in two phases, wherein each of the two phases addresses different dedicated characteristics of the input graph.

14. The apparatus according to claim 13, wherein said labeling arrangement is adapted to, in a first of the two phases:
identify strongly connected components in the input graph;
collapse each strongly connected component into a representative node; and
employ the representative node to label other items associated with the strongly connected component.

15. The apparatus according to claim 14, wherein said labeling arrangement is further adapted to, in the first phase:
identify at least one tree structure in the input graph; and
assign interval labels to nodes in the input graph based on the at least one tree structure.

16. The apparatus according to claim 15, wherein said labeling arrangement is further adapted to, in the first phase, determine a remainder graph comprising reachability information not provided by the interval labels.

17. The apparatus according to claim 16, wherein said labeling arrangement is adapted, in assigning interval labels, to identify at least one portal between nodes in the remainder graph.

18. The apparatus according to claim 16, wherein said labeling arrangement is further adapted to:
in a second of the two phases, compress reachability information in the remainder graph;
in assigning interval labels, identify at least one portal between nodes in the remainder graph; and
in compressing, assign at least one additional label to at least one portal.

19. The apparatus according to claim 11, further comprising an arrangement for identifying at least one substructure which comprises a dense submatrix, via permitting false positives in identifying at least one dense submatrix while assessing a cost of filtering out false positives.

20. A program storage device readable by machine, tangibly embodying a program of instructions executable by the machine to perform method steps for providing reachability labeling for graphs, said method comprising the steps of:
providing an input graph having at least one substructure associated therewith; and
labeling the at least one substructure with reachability information in a manner optimally configured for the at least one substructure.
